(19) United States
(12) Patent Application Publication
(10) Pub. No.: US 2026/0340738 A1
(43) Pub. Date: Oct. 29, 2026

(54) SYSTEMS AND METHODS FOR CLAIMS PROCESSING AND ADJUDICATION

(71) Applicant: NationsBenefits, LLC, Plantation, FL (US)

(72) Inventors: Robert Paul Hablutzel, Pittsboro, NC (US); Grahame Andrew Jastrebski, San Jose, CA (US); Michael Ethan Parker, Miami, FL (US); Glenn Marc Parker, Ft. Lauderdale, FL (US)

(73) Assignee: NationsBenefits, LLC, Plantation, FL (US)

(21) Appl. No.: 19/649,842

(22) Filed: Apr. 16, 2026

Related U.S. Application Data
(60) Provisional application No. 63/790,450, filed on Apr. 17, 2025.

(51) Int. Cl. G06Q 40/08; G06N 20/00; G06Q 20/38; G06Q 20/40

(52) U.S. Cl. CPC G06Q 40/084; G06N 20/00; G06Q 20/389; G06Q 20/4014; G06Q 20/4016; G06Q 20/4018; G06Q 20/405

(57) ABSTRACT

Systems, methods, and storage media for claims processing and adjudication are disclosed. An example method comprises: receiving, via a hybrid network, a user input selecting one or more elements for inclusion in the order; identifying one or more program rules based at least in part on the order; determining a cost associated with each selected element based at least on the one or more program rules associated with the member identification; sending a verification request to a user device; and based on receiving the verification request, authorizing the order; and authorizing, via an open-loop network, payment of the order, wherein the hybrid network and open-loop network are separate communication networks.

### CROSS REFERENCE TO RELATED APPLICATIONS

This application claims the benefit of priority to U.S. Provisional Patent Application No. 63/790,450, filed Apr. 17, 2025, all of the contents of which are hereby incorporated by reference in their entirety for all purposes.

### TECHNICAL FIELD

The present disclosure generally relates to claims processing and adjudication systems, and more particularly to processing claims in real time.

### BACKGROUND

Traditional claims processing systems and methods are slow, inefficient, and lack transparency. For example, traditional claims processing techniques involve a merchant (e.g., provider) converting a list of provided goods and/or services into standardized codes with predetermined prices. This conversion process can be computationally intensive for a merchant that processes hundreds or thousands of transactions each day. The merchant then sends the converted list to a program provider, who reviews the codes and performs adjudication based on one or more program rules to determine eligibility for each of the provided goods and/or services. The program provider then sends the resultant bill to the patient, detailing the predetermined prices, program coverage, and cost due. If any errors (e.g., human errors due to traditional manual review) are uncovered at any step, information may be sent back and forth between parties, thereby causing additional processing inefficiencies and delays. In such traditional claims processing techniques, a claim for provided goods and/or services may take 60 days or longer to be processed.

Further, traditional claims processing techniques are ill-equipped to identify instances of fraud (e.g., merchant billing fraud, patient insurance fraud). Due to the slow and manual nature of traditional claims processing techniques, subtle behavioral and/or data patterns indicative of fraudulent behavior may be indiscernible to human scrutiny. Further, the delayed processing and payment timeline often allows a merchant to sell goods and/or render services to a patient. Therefore, even if fraudulent transactions are identified, the merchant, the patient, and/or the program provider may have already incurred significant losses.

Thus, these existing techniques negatively impact all parties by delaying payment to the merchant and obfuscating costs to patients. It is accordingly a primary object of the disclosed embodiments to solve these problems as well as many others (e.g., similar problems associated with claims processing and adjudication).

### BRIEF SUMMARY

The present disclosure provides methods, systems, and computer-readable media for claims processing and adjudicating. According to one aspect of the present disclosure, a method may comprise: receiving, via a hybrid network, a user input selecting one or more elements for inclusion in the order; identifying one or more program rules based at least in part on the order; determining a cost associated with each selected element based at least on the one or more program rules associated with the member identification; sending a verification request to a user device; and based on receiving the verification request, authorizing the order; and authorizing, via an open-loop network, payment of the order. The hybrid network and the open-loop network may be separate communication networks.

Systems and computer-readable media (such as non‑transitory computer‑readable media) that implement the above methods are also provided.

Additional objects and advantages of the embodiments will be set forth in part in the description which follows, and in part will be obvious from the description, or may be learned by practice. The objects and advantages will be realized and attained by means of the elements and combinations particularly pointed out in the appended claims.

It is understood that both the foregoing general description and the following detailed description are examples and explanatory only and are not restrictive of the claims.

### BRIEF DESCRIPTION OF THE DRAWINGS

The accompanying drawings, which are incorporated in and constitute a part of this specification, illustrate several embodiments and together with the description, serve to explain some principles.

FIG. 1A illustrates an exemplary system for claims processing and adjudication, consistent with disclosed embodiments.

FIG. 1B illustrates an exemplary system for claims processing and adjudication, consistent with disclosed embodiments.

FIGS. 2-11 graphically depict steps of an example process of claims processing and adjudication as displayed via an exemplary graphical user interface, consistent with disclosed embodiments.

FIG. 12 illustrates an exemplary flow chart of a process for claims processing and adjudication, consistent with disclosed embodiments.

### DETAILED DESCRIPTION

Reference will now be made in detail to various embodiments, examples of which are illustrated in the accompanying drawings. Wherever possible, the same reference numbers will be used throughout the drawings to refer to the same or like parts.

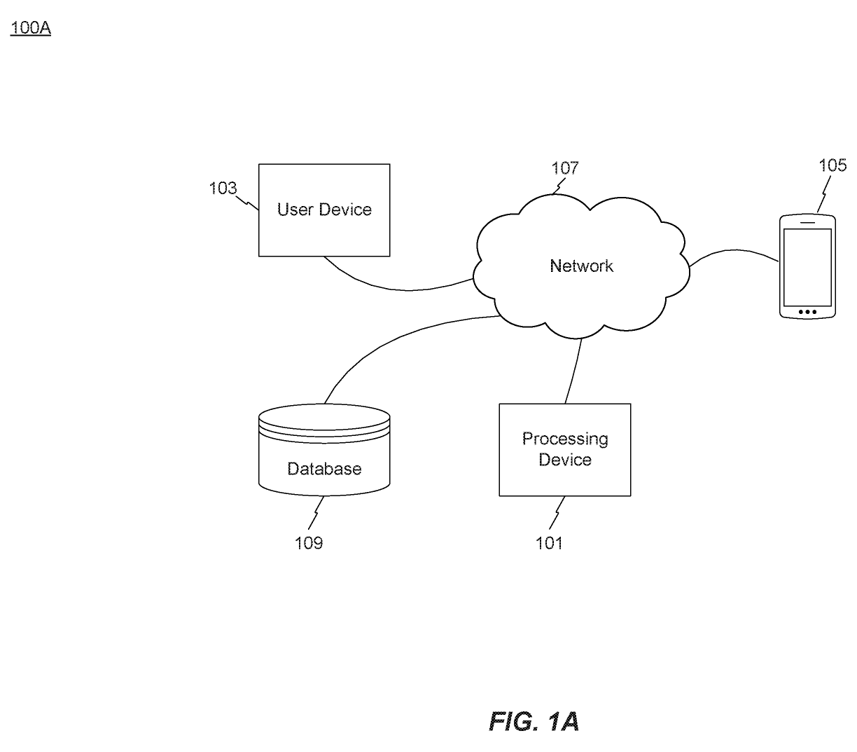

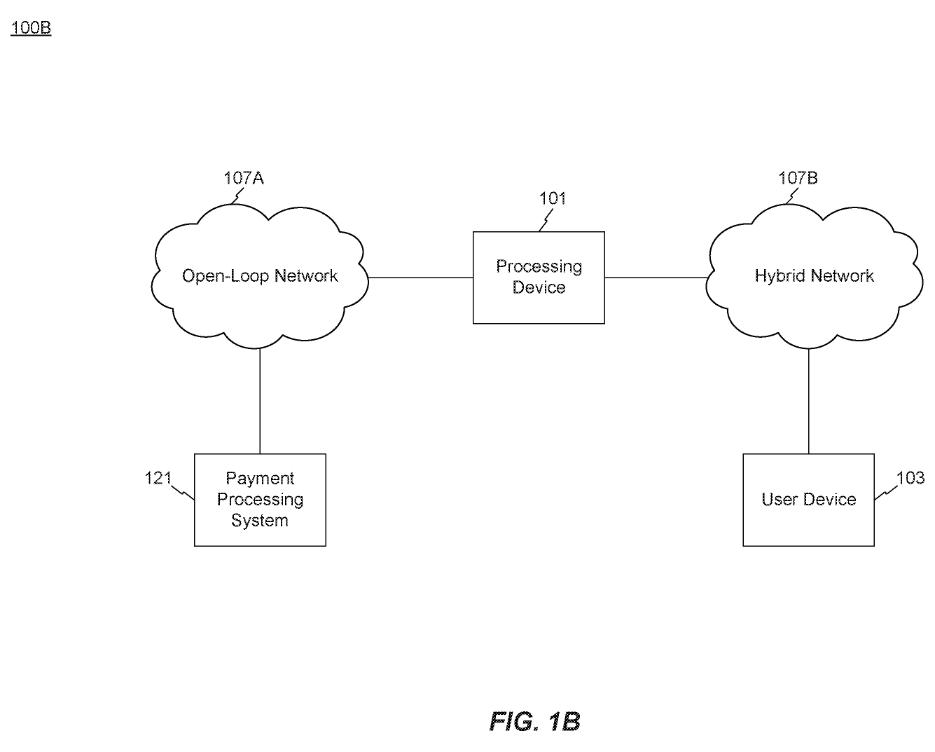

FIG. 1A illustrates an exemplary system 100A for claims processing and adjudication, consistent with disclosed embodiments. As depicted in FIG. 1A, system 100A comprises a processing device 101, a user device 103, a patient device 105, a network 107, and a database 109.

In one non-limiting example, a patient may receive a service from a doctor. The doctor may enter information (e.g., related to the provided service) in user device 103 (e.g., tablet, computer, point-of-sale (POS) device). User device 103 may then transmit the information to processing device 101. Processing device 101 may perform claims processing and adjudication services, which may include transmitting a verification request to patient device 105 (e.g., smart phone, smart watch, tablet). After receiving confirmation from the patient via patient device 105, processing device 101 may complete the claims processing and adjudication services, which may include withdrawing funds from a patient account and transmitting them to an intermediate account. The doctor may then, using user device 103, request a transfer of the funds from the intermediate account to the doctor’s account. In such an example, the entire claims processing and adjudication process may take place in real time, resulting in transparency for the patient and expedited receipt of funds for the doctor.

One of ordinary skill will understand that particular devices in system 100A can be duplicated, omitted, or modified, as appropriate. For example, user device 103 may communicate directly with processing device 101 without network 107. Further, processing device 101 and database 109 may be combined into a single device. The exemplary components and arrangements as shown in FIG. 1A are not intended to limit the disclosed embodiments.

Further, one of ordinary skill will understand that any of the devices illustrated in FIG. 1A may communicate with any other device illustrated in FIG. 1A using a wireless network, mobile network, satellite network, a physical data line, or the like. One example of a communication scheme is depicted in FIG. 1B, as further discussed below.

Processing device 101 represents one or more electronic devices configured to perform a task. Processing device 101 may include or one or more known processing devices, such as, for example, a microprocessor. In some embodiments, processing device 101 may include any type of single or multi-core processor, mobile device microcontroller, central processing unit, or any circuitry that performs logic operations. In operation, processing device 101 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in processing device 101, or elsewhere.

In some embodiments, processing device 101 may include a server configured to host or run claims processing and adjudication services. Claims processing may refer to the process of processing a claim submitted by a patient or a provider for reimbursement, payment, and/or coverage for one or more goods or services according to one or more program rules. For example, claims processing may include verifying information, checking eligibility, reviewing documentation, and ensuring compliance. Claims adjudication may refer to a step within claims processing where the claim is reviewed and assessed against the appropriate policy, contract terms, or program rules to determine how much should be paid, denied, or adjusted. For example, claims adjudication may involve applying pricing rules, checking for policy exclusions, and identifying potential fraud or errors.

In one example, processing device 101 may host a claims processing and adjudication platform, including a web-based app or a native app (e.g., desktop app, mobile app), configured to facilitate a processing and adjudication of a claim by a user. For example, processing device 101 may include a server configured to host the claims processing and adjudication platform such that a merchant may access and utilize the claims processing and adjudication platform via one or more user devices 103.

A merchant may refer to a person or business that provides a good or service for purchase by a patient. For example, a merchant may include a provider (e.g., doctor, dentist, therapist, hospital, clinic) or a retailer (e.g., pharmacy, drugstore, big-box retail store, grocery store). While some of the below exemplary description may refer to a provider, one having ordinary skill will understand that the disclosed techniques may similarly be applied to any type of merchant. A patient may refer to a person that purchases a good or service from a merchant. A member may refer to an individual who is enrolled in and/or participates in a program having one or more program rules. By way of non-limiting example, the program may include health insurance plan, a dental insurance plan, a vision insurance plan, or any other suitable spending program that adjudicates costs for goods and/or services. In some embodiments, a patient may be a member. In other embodiments, a patient may be associated with a member. For example, the patient may be a dependent of a member (e.g., primary subscriber).

In another example, processing device 101 may be configured to operate a cloud-based software as a service (SaaS) that provides the functions of item-level spend adjudication via a hybrid network disassociated from an open-loop network, as described and exemplified further below with respect to FIG. 1B. The SaaS may be accessible or operatable as a web-based app, a mobile app, a desktop app, or any other suitable means.

In some embodiments, claims processing and adjudication may include receiving a first user input. For example, processing device 101 may receive a selection indicating a location from a user device 103. The location may be a location of a business or store owned or operated by the user that provides a good or service (e.g., provider).

In some embodiments, the first input may include a provider logging into the claims processing and adjudication platform. For example, user device 103 may display the claims processing and adjudication platform and may receive a log in attempt (e.g., single sign-on, direct login) from the provider.

In some embodiments, claims processing and adjudication may include receiving a second user input. For example, processing device 101 may receive a member identification from a user device 103. The member identification may include information sufficient to identify a member uniquely. For example, the member identification may include a Primary Account Number (PAN) and/or a postal code associated with the patient. Additionally or alternatively, the member identification may include a member identification number, a group identifier, an issuer identifier, a patient and/or member name, or any other suitable information that may identify a patient or member (e.g., as participating in a program).

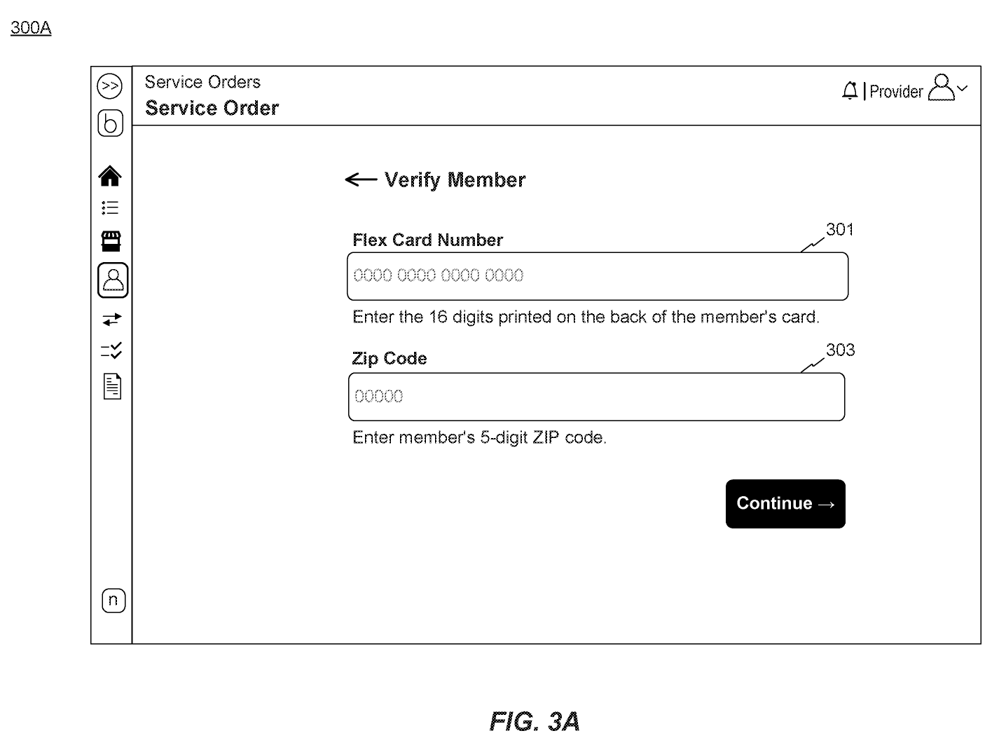

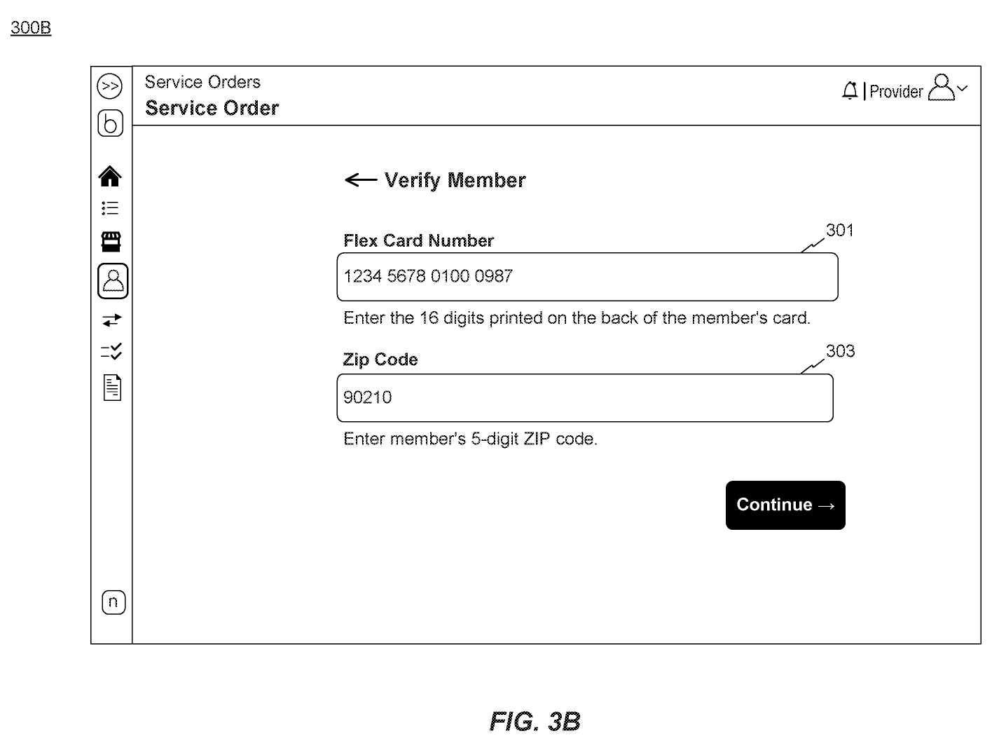

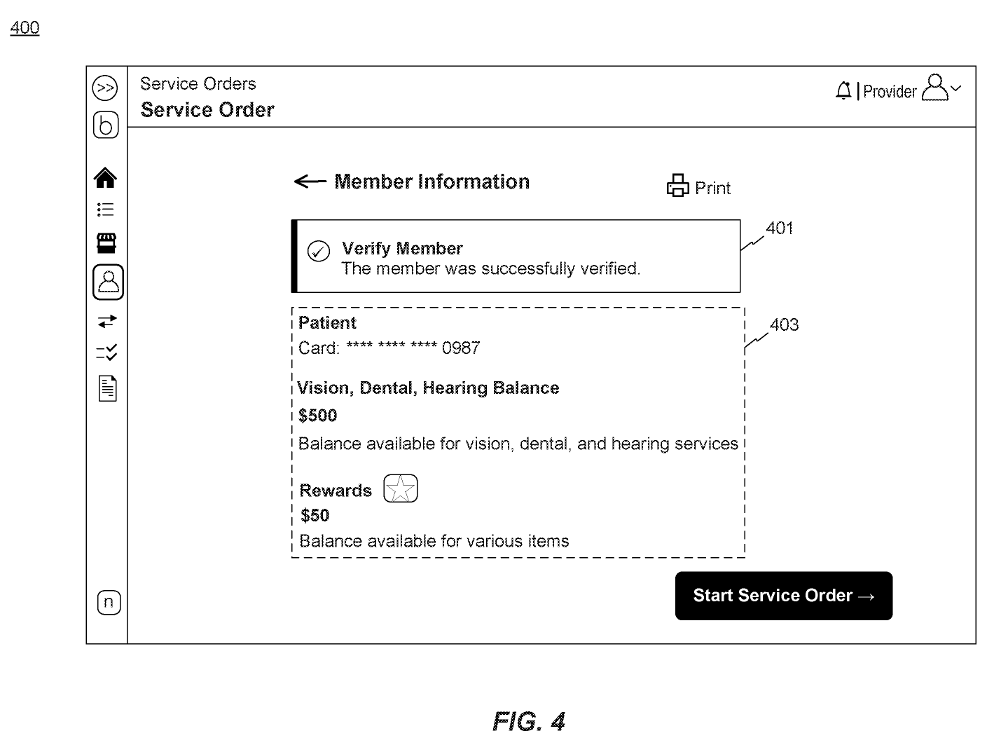

In one example, a user (e.g., patient, provider) may provide a PAN and/or a postal code associated with the patient via processing device 101 or user device 103 by manually inputting (e.g., via touchpad, via keypad) or by tapping, swiping, or dipping a payment card. Further, a user may use a card (e.g., digital card, physical card) to convey the member identification to processing device 101 and/or user device 103. In another example, a user may present the card to a card reader operatively coupled to or integrated as part of processing device 101 and/or user device 103. Presenting the card to the card reader may include any means of transmitting information associated with the card to the card reader, such as swiping a magnetic stripe card, receiving an integrated circuit (IC) card chip, tapping a near-field communication (NFC) or radio frequency identification (RFID) card, scanning a code (e.g., barcode or quick response (QR) code) on the card. Based on receiving a member identification from the card reader, user device 103 may display in the member identification in a corresponding field on a graphical user interface (GUI), as further described with respect to FIGS. 3 and 4.

In some embodiments, claims processing and adjudication may include verifying a member identification. For example, in some embodiments, processing device 101 may include a memory storing valid member identification (e.g., in a list, in a data structure, in a library). Additionally or alternatively, the valid member identification may be stored in database 109 (e.g., in a list, in a data structure, in a library). Processing device 101 may verify the received member identification by comparing it against the stored valid member identifications. When the received member identification matches a stored valid member identification, processing device 101 may determine that the received member identification is valid. When the received member identification does not match any stored valid member identifications, processing device 101 may transmit an error to user device 103, the error to be displayed on a display of user device 103 and informing the user that the input member identification is not valid and/or not eligible for claims processing and adjudication.

In some embodiments, claims processing and adjudication may include generating a template for an order. For example, processing device 101 may be configured to generate a template for an order based on the member identification and the location. The template may include a list of goods and/or services associated with the location. For example, processing device 101 may be configured to generate, for display on user device 103, a list of each good and service offered by the provider. Each element in the list may include a service code (e.g., V-code, CPT-code, CDT-code) and a name of the associated good or service. Processing device 101 may store the list in a local memory and/or database 109.

In some embodiments, user device 103 may generate the list. For example, a provider may, using user device 103, generate and transmit a list of goods and/or services provided. The list may include a service code associated with each good and/or service.

In some embodiments, the template may be associated with a particular provider. For example, each provider may have their own unique template (e.g., representing the services offered by the provider). Additionally or alternatively, same or similar providers (e.g., working in a same field, providing a similar good and/or service) may share a common template. In some embodiments, each template may be stored in a memory, such as locally on processing device 101 or user device 103 and/or in database 109.

In some embodiments, the list may specify or indicate a maximum cost associated with each good and/or service. For example, the provider may specify a maximum cost to be charged to a patient for each good and/or service. The maximum cost may be stored in a memory of processing device 101 and/or database 109. In some embodiments, processing device 101 may associate one or more maximum costs with a corresponding template. For example, processing device 101 may associate one or more maximum costs associated with one provider with one or more corresponding goods and/or services. In some embodiments, processing device 101 may generate or modify one or more program rules based on one or more maximum costs. For example, processing device 101 may generate or modify one or more program rules that restrict a maximum cost for a corresponding good and/or service.

In some embodiments, claims processing and adjudication may include receiving a third user input. For example, processing device 101 may receive selections of one or more elements for inclusion in the order from user device 103. The one or more elements may include one or more goods sold to and/or one or more services rendered to a patient. A provider may, via user device 103, select (e.g., by clicking, tapping, checking) the goods and/or services provided to the patient, thereby adding each selected element to the order.

In some embodiments, claims processing and adjudication may include determining a cost associated with each selected element based at least on one or more program rules associated with the member identification. For example, processing device 101 may include a pricing manager, a rules engine, and a basket analyzer. A pricing manager may refer to a processor (e.g., virtual, hardware) configured to determine a cost of goods and/or services of a claim based on one or more program rules. In one example, the one or more program rules may include a predetermined cost set by a provider or an operator of system 100A. Additionally or alternatively, in one example, the one or more program rules may include an analysis for each good and/or service at an item-level, a category-level, a sub-category-level, or any other suitable classification system. A rules engine may refer to a processor (e.g., virtual, hardware) configured to store, to supply, or to apply program rules. A basket analyzer may refer to a processor (e.g., virtual, hardware) configured to perform basket adjudication services on goods and/or services of the claim. Basket adjudication services may include examining each good and/or service provided at an item level, a category level, or a sub-category level to determine an eligibility, availability of funds, discount eligibility, and redemption. An eligibility may include determining whether a good or service is eligible for payment under a specific set of rules (e.g., as defined by a healthcare provider). Availability of funds refers to determining what dollars (or other currency) are available to be spent on eligible items. Discount eligibility and redemption relate to determining that a specific good and/or service has, at an item-level, a category level, or a sub-category level, a digital discount that can be applied, and then subsequently using the digital discount on the item before consuming other funds to pay for the item. Additional examples of a basket analyzer configured to perform basket adjudication services may be found in U.S. App. Nos. 18/504,801, 18/817,018, and 19/182,408, each of which are incorporated herein by reference in their entireties for all purposes.

In one example, processing device 101 may receive an order including one or more selected goods and/or services for inclusion in an order. A rules engine may identify and apply one or more program rules associated with the goods and/or services received based on the member identification. For example, based on the member identification, processing device 101 may be configured to determine an associated plan or program including one or more program rules for pricing and/or adjudication for some goods and/or services. A basket analyzer may perform basket adjudication services on the selected goods and/or services of the order to determine their respective discount eligibility and redemption. A pricing manager may determine a cost for each selected good and/or service. For example, pricing manager may determine at least one of an approved cost, an out-of-pocket cost, or a total cost for each selected good and/or service. A total cost may refer to a cost for each good and/or service provided. For example, the total cost for a good or service provided may be a predetermined value (e.g., as defined by a provider, by an operator of processing device 101). An approved cost may refer to a cost that is a fraction (e.g., 0%, 10%, 25%, 50%, 100%) of the total cost that is eligible for payment using an approved account. Additionally or alternatively, an approved cost may be a predetermined fixed value based on one or more program rules. The approved account may include one or more payment methods, including a purse, an account, or a payment card associated with the patient. An out-of-pocket cost may refer to a cost that is a fraction (e.g., 0%, 10%, 25%, 50%, 100%) of the total cost that is not eligible for payment using an approved account. Additionally or alternatively, an out-of-pocket cost may be a predetermined fixed value based on one or more program rules. The out-of-pocket cost may be paid by the patient using another payment source (e.g., cash, debit card, credit card, check) that is not an approved account. The approved cost and the out-of-pocket cost may sum to equal the total cost.

In some embodiments, the rules manager may include a shared set of program rules. For example, the shared set of program rules may define a common fee schedule for use with any number of providers. The providers may each agree or consent to the rules manager applying the shared set of program rules to orders. In one example, the rules manager may apply a predetermined maximum cost constraint to each element of each order from any consenting providers. In some embodiments, the rules manager may include one or more customized program rules. For example, a provider may provide a customized set of program rules defining a fee schedule for provided goods and/or services. The rules manager may be configured to manage and apply any number of sets of program rules for any number of providers.

In some embodiments, the basket analyzer may be configured to adjudicate item information content based on the selected elements in the order, patient information, and/or the one or more program rules. The basket analyzer may preprocess payment information through a ledger. The preprocess may include determining good or service eligibility within a specific program to compare basket goods or services using specific program rules. The program rules can include, but are not limited to, a particular health program or other set of program rules (e.g., as supplied by the rules engine). The basket analyzer may define an application program interface (API) structure that allows user device 103 to present any combination of the category information data, sub-category information data, or item information data for adjudication following a transmission of the order. The API structure can facilitate communication between user device 103 and processing device 101 (e.g., via hybrid network 107B, as further described and exemplified with respect to FIG. 1B). The API may describe the order in two or more data sections including: 1) transaction information and 2) item information content information. Transaction information comprises data elements that define the specific provider and user device 103 initiating the transaction, such as merchant identifier (“MID”), terminal identifier (“TID”), as well as timestamps and transaction IDs to identify the specific transaction, and an identification of the cardholder (e.g., patient, member identification). The item information content section includes a record for each good and/or service at an item level, category level, or sub-category level being purchased within the transaction. Detailed information typically includes a description consisting of a good or service code, unit price, unit of measure, tax and fee elements, weight, and good or service description.

In a further aspect, the basket analyzer may be configured to determine a good or service eligibility. The basket analyzer may adjudicate transaction data by managing and applying rules for financial constraints and/or item level, category level, or sub-category level eligibility and velocity constraint. Eligibility may depend on the item (e.g., good, service), the plan, and member information such as previous purchase history, medical conditions, or other attributes. The basket analyzer may further include a plan and provider constraint to determine accessibility for a particular provider and/or a plan constraint such as health care plan. Processing device 101 may be configured to analyze and record qualified purchase activities. Additionally or alternatively, processing device 101 may be configured to store data to generate a system of record for compliance, audit, statements, analytic study, or other similar uses.

Processing device 101 may further engage in collaborative authorization to manage tender authorizations and transactional integrity. The collaborative authorization is an interaction—separate from the ISO 8583 standard—between an issuer processor and a secondary ledger entity (e.g., via open-loop network 107A, as described and exemplified with respect to FIG. 1B). Processing device 101 may be configured to execute account ledgers for maintaining balances for any type of account (e.g., Member, Funding (FBO), digital discounts, rewards, and spending certificates). The collaborative authorization may comprise processing the order and returning a tender authorization. In some embodiments, authorization may include receiving the order, which may include a transaction identifier and the selected elements. In some embodiments, multiple orders may be aggregated together and identifying common or shared program rules associated with the aggregated orders. The transaction identifier is directly related to the order as an identifier for the superset of data. The program rules may be used to determine good or service eligibility for payment. For example, the program rule could limit a member (e.g., patient) to $50 per month for over-the-counter medication from a select group of providers, or restrict a member from purchasing items from a liquor store (even if they would otherwise be permitted), or roll over a member’s funds to the first 15 days of the month, etc. Once the good or service eligibility is determined, processing device 101 may generate a transaction message indicating that the good or service was purchased. The transaction data may be audited by matching the good or service with pricing data associated with the good or service.

In some embodiments, the pricing manager may be configured to determine a maximum cost. For example, processing device 101 may store (e.g., in database 109, in a memory) a maximum cost associated with a good and/or service, including, for example, as a program rule managed by a rules manager. The maximum cost may be received from or supplied by a provider. Additionally or alternatively, the maximum cost may be set by an operator of processing device 101, as described and exemplified above. For example, the operator or owner of processing device 101 may set a maximum cost for any number of goods and/or services provided by any provider. When pricing manager determines that the total cost is greater than the maximum cost for a good or service, pricing manager may automatically lower the total cost to the maximum cost. For example, if pricing manager determines the total cost for a healthcare good is $100 and the maximum cost for the healthcare good is $80, then pricing manager automatically lowers the total cost of the healthcare good to $80. Pricing manager may similarly or proportionally lower an approved cost and/or an out-of-pocket cost after lowering a total cost. In one example, the cost reduction may reduce an amount the provider may receive and/or may increase an out-of-pocket cost of the patient. In some embodiments, the pricing manager may record and store the cost reduction in a memory (e.g., local to processing device 101, in database 109). Processing device 101 may update the order accordingly such that elements reflect their adjusted cost.

In some embodiments, claims processing and adjudication may include receiving a fourth user input. For example, a provider may upload, via user device 103, one or more documents to substantiate the order. Substantiating documents may include official records, forms, or other document evidence that may support or validate a claim, statement, or report. In one example, substantiating documents may include patient records, doctor’s notes, and/or test results. By way of non-limiting example, for an order including x-ray services, the provider may upload an x-ray scan of the patient and associated doctor’s notes. The substantiating documents may include files of any type, such as PDF files, DOC files, DOCX files, CSV files, JPEG files, PNG files, or the like.

In some embodiments, claims processing and adjudication may include provider authentication. For example, user device 103 may prompt a user (e.g., provider) to confirm that the selected elements (indicating the provided goods and/or services) were rendered to the patient, such as via a checkbox or signature panel. The provider authentication may be timestamped and/or encrypted and stored as part of an audit trail to ensure data security and compliance.

In some embodiments, processing device 101 may, after performing claims processing and adjudication services, transmit a processed order to user device 103. For example, processing device 101 may transmit (e.g., via hybrid network 107B) the processed order including a cost breakdown for each selected element to user device 103. The processed order may also include the provider authentication verifying each selected element.

In some embodiments, claims processing and adjudication may include transmitting a verification request to a user device. The verification request may include an item-level breakdown of costs (including a total cost, an approved cost, an out-of-pocket cost) for each good and/or service provided. Further, the verification request may include a Two-Factor Authentication (2FA) Request or a Short Message Service (SMS) message to a patient device (e.g., smartphone, tablet). The 2FA request or SMS message may include a link or code, a push notification, or any other suitable messaging or authentication method. For example, processing device 101 may transmit, for display on patient device 105 (e.g., smartphone, computer, laptop, tablet, smart watch), the verification request including the cost breakdown of each good and/or service and an authentication request (e.g., request for signature, request for confirmation). In this way, the patient may review a list of the goods and/or services received and their cost breakdown in real time. The patient may, via patient device 105, transmit a verification or authorization of the order. For example, the patient may sign, using patient device 105, (e.g., digitally drawn, typed) the verification request. In another example, the patient may select an option box indicating the patient agrees to be charged for the order.

In some embodiments, claims processing and adjudication may include receiving the verification request from the user device. For example, processing device 101 may receive, from patient device 105, an authorized verification request (e.g., having been signed by the patient). Processing device 101 may store the authorized verification request in a memory (e.g., database 109). For example, processing device 101 may timestamp and/or encrypt the patient authorization and then store the patient authorization as part of an audit trail to ensure data security and compliance.

In some embodiments, claims processing and adjudication may include, based on receiving the verification request, authorizing the order. For example, processing device 101 may, after receiving the authorized verification request, withdraw or subtract an amount from the approved accounts associated with the patient. Processing device 101 may be configured to allocate those withdrawn funds to an intermediate account. For example, processing device 101 may communicate with an issuer processor and/or merchant acquirer via an open-loop network (e.g., open-loop network 107A, as further described and exemplified below with respect to FIG. 1B) to complete the transaction.

In some embodiments, claims processing and adjudication may include receiving a fifth user input. For example, a provider may input a desired duration until the withdrawn funds in the intermediate account may be transferred to a provider account. In one example, a provider may select to receive the funds instantly, including a cost of a predetermined percentage of the funds (e.g., 10%, 5%). In another example, a provider may select to receive the funds within 5 days, including a cost of a second, lower predetermined percentage of the funds (e.g., 5%, 2.5%). In yet another example, a provider may select to receive the funds within 60 days, including a third, lowest predetermined percentage of the funds (e.g., 1%, 0%).

In some embodiments, processing device 101 may be configured to perform claims processing and adjudication in real time. Real time may refer to an immediate or nearly immediate processing of data or events as they occur, typically without any noticeable delay. For example, processing device 101 may be configured to perform real-time processing and adjudication of a received claim. Processing device 101 may utilize or leverage a set of program rules (e.g., managed by a rules manager), which may be associated with one or more programs or other member information, to determine the validity of a specific claim (e.g., does the claim comply with the applicable program rules, is the claim potentially fraudulent). The program rules may be based on hard-coded programs, business rules, data science, models, artificial intelligence, or similar mechanisms for making decisions based on a set of complex inputs and states.

In some embodiments, processing device 101 may include a memory. For example, processing device 101 may include a local hard drive, a connected (e.g., via wire, via network 107) database (e.g., database 109), or any other suitable storage media. Processing device 101 may be configured to store data associated with each order in the memory. For example, processing device 101 may store all sent or received files (e.g., verification request, substantiating documents, payment receipts) associated with a same order (e.g., chronological, timestamped order) in a same memory location. This data recordation and timestamped and/or encrypted storage may be part of an audit trail to ensure data security and compliance. Additionally or alternatively, processing device 101 may store the data associated with each order in database 109.

In some embodiments, processing device 101 may include a machine learning model. A machine learning model refers to a computational model or algorithm that is trained to perform a specific task without being explicitly programmed for that task using learned patterns and relationships to make predictions or decisions. By way of non-limiting example, the machine learning model may include a logistic regression model, a decision tree model, a random forest model, an isolation forest model, a One-Class Support Vector Machine (SVM) model, an autoencoder neural network, or any other suitable machine learning model or algorithm trainable to identify trends and/or outliers in data. The machine learning model may be configured to receive input data from other devices such as user device 103, database 109, or the like.

In some embodiments, the machine learning model may be run on a machine learning system separate from processing device 101. A machine learning system may refer to one or more processors (e.g., virtual, hardware) that are configured to provide functionality for making predictions, decisions, or inferences based on data. In operation, a machine learning system may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in the machine learning system, or elsewhere.

In some embodiments, processing device 101 may generate a training data set. For example, the training data set may comprise historical transaction data stored in a memory (e.g., database 109). Historical transaction data may include any data from one or more previous orders, including goods and/or services provided, cost breakdown, patient authorization, received documents, and/or payment receipts. Historical transaction data may also include a member identification, a date of purchase or service, or any other relevant and stored documentation of any step in the claims processing and adjudication process.

In some embodiments, processing device 101 may train the machine learning model using the created training data set. Training the machine learning model may include a single stage or multiple stages of supervised, unsupervised, and/or semi-supervising training. Training the machine learning model may include using subsets of the training data, which may be labeled or unlabeled, as training data and other subsets of the training data as testing data.

In some embodiments, processing device 101 may train the machine learning model, using the created training data set, to determine a fraud value associated with an order. For example, the machine learning model may be configured to determine a likelihood that an order is fraudulent (i.e., a fraud value) based on, for example, a signature verification, a frequency analysis, or an item analysis. A signature verification may include image analysis comparing a patient signature in an order with a verified patient signature to determine the probability the patient signature in the order is authentic. Further, the training data may include labeled examples of patient signatures. A frequency analysis may include a time-based analysis to determine if the frequency of orders for a patient exceeds an expected or typical frequency threshold (e.g., based on historical transaction data). Further, the training data may include historical transaction data, which may be timestamped. An item analysis may include determining if a received good or service is expected or reasonable for a patient (e.g., based on historical transaction data). Further, the training data may include historical transaction data, which may include item-level transaction data. If an order does not pass an analysis, including but not limited to one or more of the above-mentioned analyses, the machine learning model may output a fraud value indicating an increasing chance of fraud for the order based on an increasing number of failed analyses. If an order passes each analysis, the machine learning model may output a fraud value indicating no or very low chance of fraud for the order.

By way of non-limiting example, processing device 101 may train the machine learning model to identify a velocity or frequency of a good or service associated with a same patient. If a same patient is associated with two separate orders for extraction of a same tooth (e.g., as substantiated by uploaded x-rays), the machine learning model may determine a fraud value for the second order indicating a high likelihood of fraud. Processing device may timestamp, encrypt, and/or store this identification and corresponding fraud value as part of an audit trail to ensure data security and compliance.

In some embodiments, processing device 101 may train the machine learning model, using the created training data set, to determine a new program rule or to update an existing program rule. For example, the machine learning model may be configured to recommend a new program rule or an update to an existing program rule based on the historical transaction data. By way of non-limiting example, processing device 101 may train the machine learning model to determine that current program rules result in an amount of wasted or unspent funds in an approved account and to recommend an adjustment to the program rules to reduce the determined amount of wasted or unspent funds (e.g., by reallocating what goods and/or services may be purchased using the funds).

In some embodiments, processing device 101 may train the machine learning model, using the created training data set, to generate a template for an order. By way of non-limiting example, processing device 101 may train the machine learning model to generate a template for an order based on received substantiating documents.

In some embodiments, processing device 101 may train the machine learning model, using the created training data set, to perform data extraction services. For example, the machine learning model may be configured to extract data (e.g., text, signature, image) from documents, forms, invoices, images, scans, documentation, or any other received substantiating document. In one example, the machine learning model may be configured to perform Optical Character Recognition (OCR), document layout analysis, Intelligent Document Processing (IDP), handwriting recognition / handwritten text recognition, table and form extraction, computer vision, Natural Language Processing (NLP), or any other suitable data extraction method. The machine learning model may be configured to extract data from received documents and store the extracted data in a memory (e.g., memory of processing device 101, database 109). Processing device 101 may timestamp and/or encrypt the extracted data as part of an audit trail to ensure data security and compliance.

In some embodiments, processing device 101 may train the machine learning model to compare data extracted from the substantiating documents and the selected goods and/or services to determine a fraud value. For example, if a provider uploads an x-ray scan of a patient for an order but selects that an MRI scan was provided, processing device 101 may, using the machine learning model, output a fraud value indicating the order may contain a fraudulent element. In one example, processing device 101 may transmit, for display on user device 103, a warning or error message indicating which selected good or service may be erroneously or fraudulently selected.

In some embodiments, processing device 101 may train the machine learning model to authorize an order. For example, instead of or in addition to requiring a patient to authorize a verification request (e.g., via a patient device 105), processing device 101 may train the machine learning model to authorize the order on behalf of the patient. For example, if the machine learning model determines the order has a fraud value indicating no or very low chance of fraud, the machine learning model may authorize the order. In some embodiments, the machine learning model may only authorize orders for approved members. For example, a patient may provide consent and authorization for automated order verification. Processing device 101 may record and store the machine learning model-generated authorization in a memory (e.g., in database 109). Processing device 101 may timestamp and/or encrypt the authorization as part of an audit trail to ensure data security and compliance.

In some embodiments, processing device 101 may identify instances of attempted price gouging. For example, processing device 101 may record and store in a memory (e.g., database 109) each order comprising an element whose submitted cost was greater than the maximum cost determined by the pricing manager (e.g., cost was lowered to the determined maximum cost). Processing device 101 may identify a provider whose submitted orders include greater than a predetermined threshold number of adjusted orders as potentially gouging or inflating prices. In some embodiments, processing device 101 may train the machine learning model to identify a provider that may be gouging or inflating prices. For example, processing device 101 may train the machine learning model using historical transaction data to identify a provider associated with frequent and/or many instances of cost adjustments due to a submitted cost exceeding a maximum cost.

In some embodiments, processing device 101 may modify one or more program rules. For example, processing device 101 may be configured to modify a base set of program rules to tailor a use for a particular provider. In one example, an operator of processing device 101 may modify one or more program rules to modify basket adjudication services. For example, processing device 101 may increase a spend allocation associated with a particular provider, good, and/or service based on a received request from a provider. By way of a non-limiting example, a provider may charge $110 for an operation, and the program rules may only cover $100 of charge, resulting in $10 of out-of-pocket fees for a patient. Processing device 101, the machine learning model, and/or an operator of processing device 101 may determine that the provider charges a reasonable rate (e.g., based on historical transaction data) and may accordingly increase the spend allocation for the operation to be $110 for that provider to eliminate patient out-of-pocket fees.

In some embodiments, processing device 101 may associate a member identification with a set of program rules. For example, processing device 101 may, with or without the machine learning model, determine that a first member identification is associated with a first patient having a first plan and that a different second member identification is associated with a second patient having a second plan. Processing device 101 may then apply the appropriate program rules associated with the respective plan when generating the template.

In some embodiments, processing device 101 may associate a member identification with more than one set of program rules. For example, processing device 101 may, with or without the machine learning model, determine that a first member identification is associated with a first patient having a first plan and a second plan. Processing device 101 may then apply the appropriate program rules based on both the first plan and the second plan when generating the template.

User device 103 represents a computing device configured to perform one or more processes consistent with the disclosed embodiments. For example, user device 103 may be implemented as a notebook computer, a mobile device with computing ability, a desktop computer, tablet, or the like. User device 103 may include a visual display (such as a screen, touchscreen, monitor, or the like) that may display information to the user. User device 103 may communicate with processing device 101 using a wireless network, a mobile network, a satellite network, or the like. In operation, user device 103 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in user device 103, or elsewhere.

In some embodiments, user device 103 may be configured to receive data from a user. The data may involve a first input, a second input, a third, input, a fourth input, and/or a fifth input. Receiving data, as used herein, may refer to accepting, taking in, admitting, gaining, acquiring, retrieving, obtaining, reading, accessing, collecting, or any other operation for inputting the data. User device 103 may be configured to accept free form text (e.g., alphanumeric characters) or box selections as inputs. User device 103 may further be configured to accept files as input, such as PDF files, DOC files, DOCX files, CSV files, JPEG files, PNG files, or the like.

In one example, user device 103 may be configured to receive an account selection from a user. For example, a user may select a location of the provider.

In another example, user device 103 may be configured to receive patient data from a user (e.g., provider). Patient data may include a member identification. As a non-limiting example, a member identification may include a card identifier or a postal code. For example, a card identifier may include a PAN associated with the patient receiving goods or services. A postal code may include a ZIP code and may be associated with the patient (e.g., as stored in database 109). Patient data may also include substantiating documents associated with the patient and uploaded by the provider.

Patient device 105 represents a personal computing device of a patient. For example, patient device 105 may include a desktop computer, a laptop computer, a telephone, a smartphone, a smartwatch, a tablet, or any other personal computing device. Patient device 105 may be configured to communicate with processing device 101 (e.g., via network 107). For example, patient device 105 may be configured to receive a verification request from processing device 101. Further, patient device 105 may be configured to receive an input, including a signature (e.g., typed, drawn) from the patient. Additionally or alternatively, patient device 105 may be configured to transmit an authorized verification request to processing device 101.

Network 107 can be a local area network (LAN), a wide area network (WAN), a mesh network, a hybrid network, or other wired or wireless networks. Network 107 may include the Internet or some other public or proprietary network. Devices of system 100A (including other, unpictured devices) can be connected to network 107 through a network interface, such as by wired or wireless communication. The connections can be any kind of local, wide area, wired, or wireless network, including network 107 or a separate public or proprietary network.

In some embodiments, network 107 may include an open-loop network (e.g., open-loop network 107A). In such embodiments, processing device 101 may be used as part of a payment enabling system, such as one implemented via network 107. Processing device 101 may be configured to facilitate payments by patients or to providers through secure and encrypted transactions. Some transaction messaging can be formatted using an ISO 8583 standard or an arrangement of discrete elements. The ISO 8583 standard is intended to support using a payment instrument (e.g., a card, tokens, cash, QR code, or other payment instrument) to purchase goods or services. The ISO 8583 standard also defines a set of data elements, such as card number, card verification value (CVV), price amount, tax amount, etc. and a mechanism for structuring and transmitting the data from the provider to the card issuer. The messages support payment operations, such as authorizations and refunds, as well as reversals and voids.

Database 109 represents one or more devices configured to store data. A database may refer to an electronic filing system that stores data in a structured way. Examples of databases may include relational databases, NoSQL databases, graph databases, in‑memory databases, or the like. Database 109 may be, in some embodiments, a device storing data in one or more of a relational database, a non‑relational database, a flat file, a CSV (comma separated value) file, a Microsoft Excel file, or the like.

In some embodiments, database 109 may be configured to store data. In operation, database 109 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in database 109, or elsewhere.

For example, as discussed above, database 109 may store data relating to claims adjudication and processing, such as member identification, provider information, one or more program rules, transaction data, patient data, and the like. Database 109 may store this data as encrypted and/or timestamped data so that the data may clearly represent what data was transmitted by what parties at what times as part of an audit trail to ensure data security and compliance.

FIG. 1B illustrates an exemplary system 100B for claims processing and adjudication, consistent with disclosed embodiments. As depicted in FIG. 1B, system 100B comprises processing device 101, user device 103, an open-loop network 107A, a hybrid network 107B, and a payment processing system 121. One of ordinary skill will understand that particular devices in system 100B can be duplicated, omitted, or modified, as appropriate. The exemplary components and arrangements as shown in FIG. 1B are not intended to limit the disclosed embodiments.

An open-loop network may refer to a payment system that allows transactions to be processed across multiple, interconnected financial institutions. For example, processing device 101 may communicate with payment processing system 121 via open-loop network 107A. Payment processing system 121 may include an acquirer processor, an issuer processor associated with a payment instrument, and/or a financial institution associated with the provider. By way of a non-limiting example, communications over open-loop network 107A may use the ISO 8583 messaging standard.

A hybrid network may refer to a communication system that is compatible with open-loop network devices and allows communication of information that may not be permitted or possible under the open-loop network. For example, processing device 101 may communicate with user device 103 using hybrid network 107B to transmit and receive messages including data structures with line-item details, which may not be permitted under the communication constraints of open-loop network 107A.

As depicted in FIG. 1B, processing device 101 may be configured to communicate via both open-loop network 107A and hybrid network 107B. For example, processing device 101 may communicate item-level spend adjudication with user device 103 via hybrid network 107B, which may be disassociated and separate from open-loop network 107A. In this way, system 100B may be issuer-agnostic and may be compatible with any payment processing system 121 via open-loop communication.

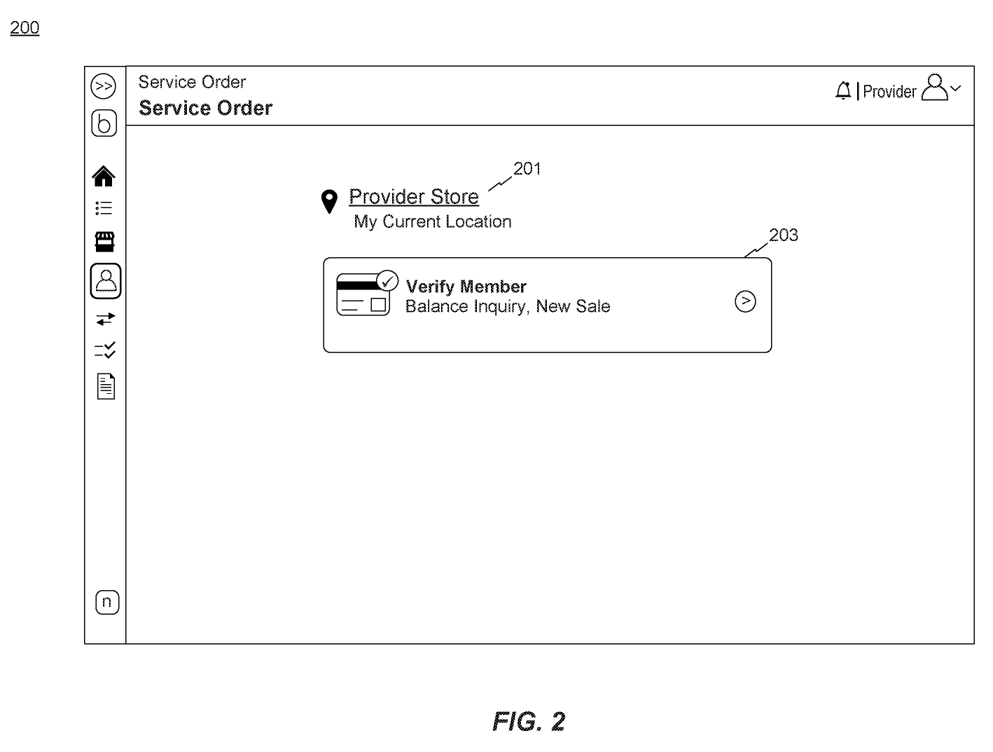

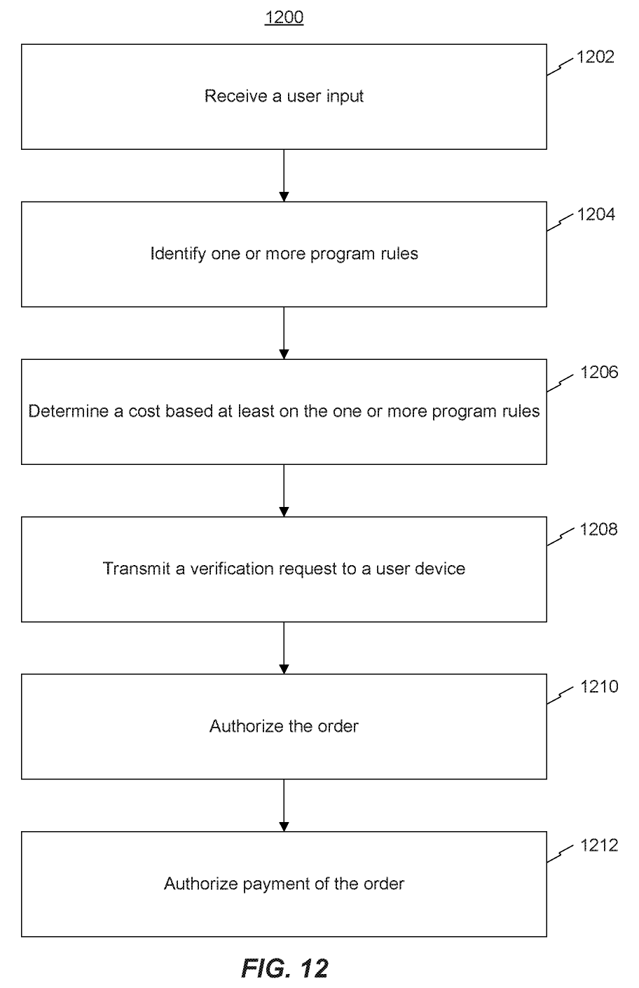

FIGS. 2-11 graphically depict steps of an example process of claims processing and adjudication as displayed via an exemplary GUI, consistent with disclosed embodiments. One having ordinary skill in the art will understand that example process depicted in FIGS. 2-11 is similar to process 1200 as described and exemplified below with respect to FIG. 12.

As depicted in FIG. 2, user device 103 may display GUI 200. GUI 200 may permit a user to select a location or to begin a member verification process. For example, a user may interact with (e.g., tap, click) GUI element 201 to initiate a location selection. The location selection may include selecting a location, for example, from a displayed map or from a dropdown list. Additionally or alternatively, a user may interact with GUI element 203 to initiate a member verification process.

As depicted in FIG. 3A, user device 103 may display GUI 300A. GUI 300A may appear after a user interacts with GUI element 203. GUI 300 may also prompt a user to input a member identification, including a PAN and a ZIP code, by interacting with GUI elements 301 and 303. In some embodiments, a user may manually input the member identification (e.g., by typing on a keyboard). In some embodiments, a user may present a card containing the member identification, such as a payment card or other identification card, to a card reader.

As depicted in FIG. 3B, user device 103 may display GUI 300B. GUI 300B includes exemplary values for the member identification as entered by a user. In some embodiments, based on receiving the member identification data from the card (e.g., swiping a magnetic stripe card, receiving an IC card chip, tapping an NFC or RFID card, scanning a code on the card), user device 103 may automatically populate GUI elements 301 and 303 with the received member identification data.

As depicted in FIG. 4, user device 103 may display GUI 400. GUI 400 may appear after a user selects to continue after inputting the member identification. For example, user device 103 may transmit the member identification to processing device 101 for verification against a stored list of member identifications. Based on positively verifying the received member identification (e.g., received member identification matches a stored member identification), processing device 101 may transmit program information associated with the member identification. For example, user device 103 may display GUI 400 including GUI element 403 depicting the program information, such as at least part of the member identification and an amount of available funds are associated with the member, as well GUI element 401 indicating that verification was successful. In some embodiments, a plurality of funds may be associated with a member. For example, a member may have a first fund for vision, dental, and health spending and a second fund of rewards money for spending. In general, a single member may be associated with any number of funds, each corresponding to a different program or program rules. Through GUI 400, user device 103 is able to display real-time program information for a patient.

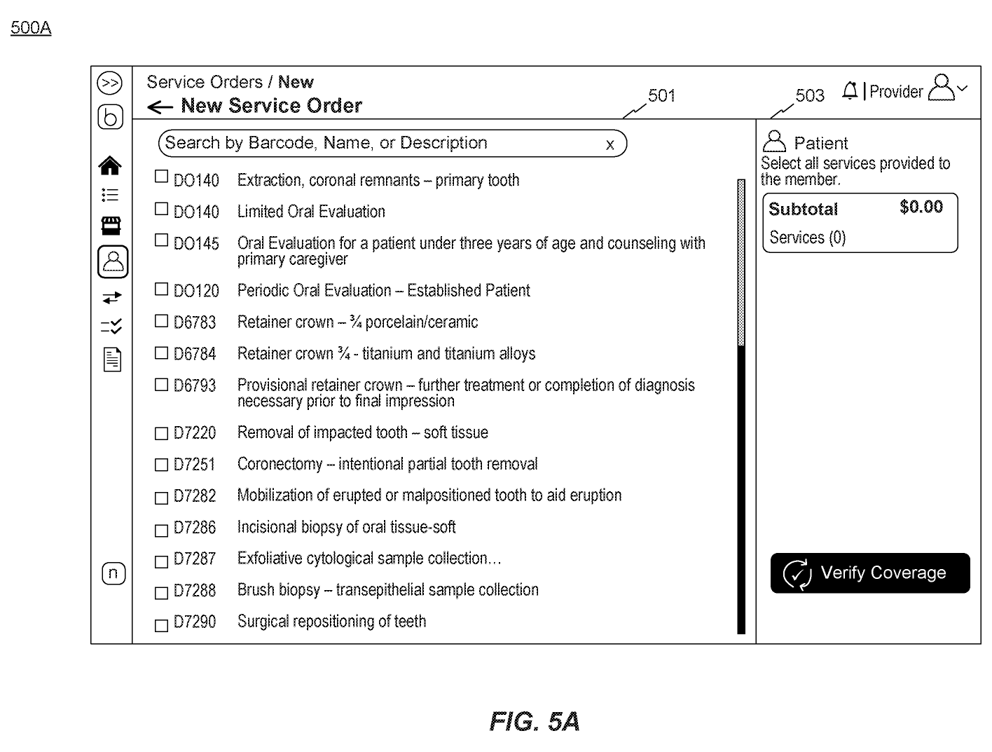

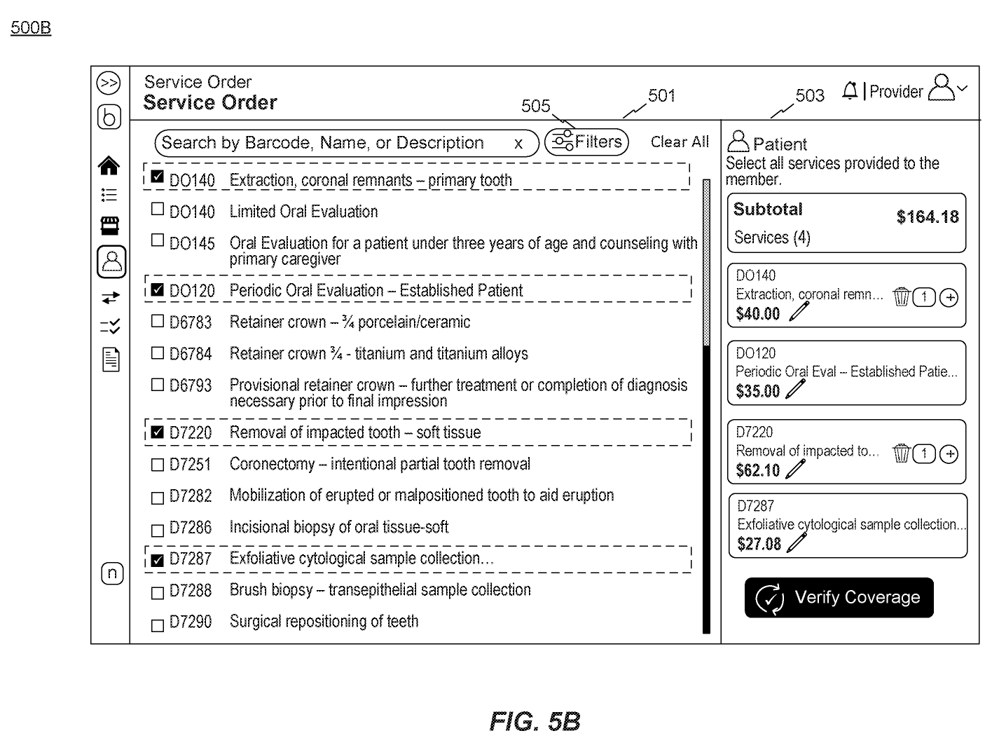

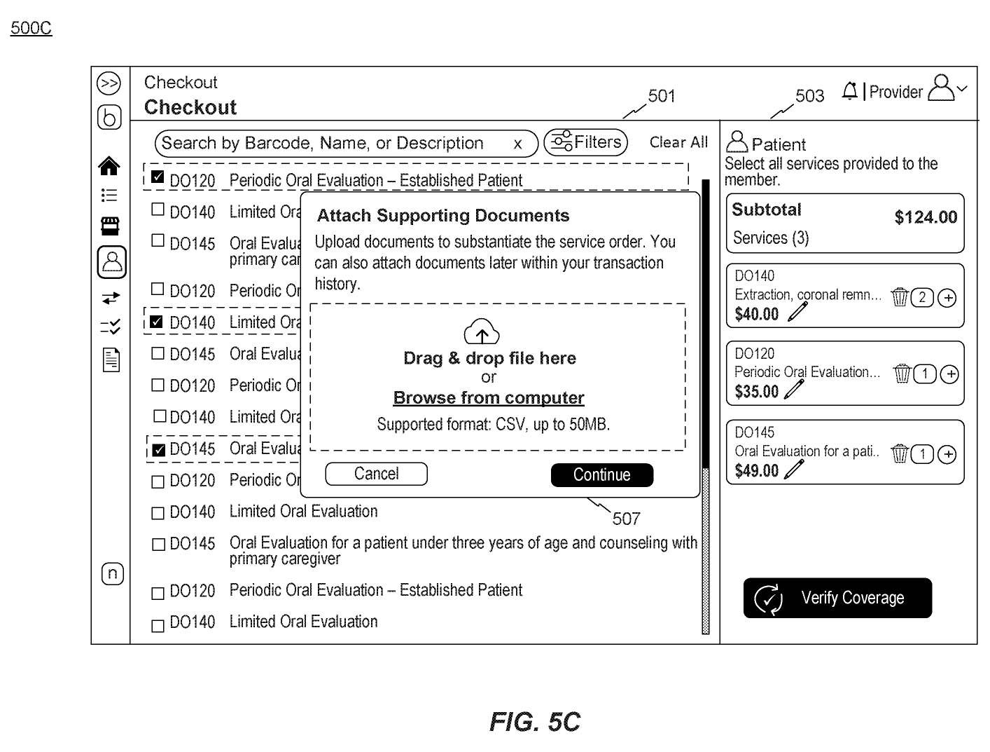

As depicted in FIG. 5A, user device 103 may display GUI 500A. GUI 500A may appear after a user selects to start a service order. GUI 500A may prompt a user (e.g., provider) to select which goods and/or services were provided to the patient. GUI 500A may include a service window 501 including a list of goods and/or services and their respective service code. Service window 501 may further include a search bar to search for the list of goods and/or services. As shown in FIG. 5B, service window 501 may further include a filtering feature 505 to filter the list of goods and/or services.

GUI 500A may also include a dynamic receipt window 503. The dynamic receipt may display each selected good and/or service and the associated cost, as depicted in GUI 500B of FIG. 5B. As a user (e.g., provider) selects a good or service, processing device 101 automatically determines a total cost for the selected good or service and updates the dynamic receipt accordingly. For example, user device 103 may request a template for the provider selected via GUI 200 from processing device 101, including associated costs for each element and one or more program rules for each element. In such an example, as the user selects an element from service window 501, user device 103 uses the template-provided program rules to determine the cost for each selected element. Additionally or alternatively, the costs for each element may be stored locally in user device 103 and may be predetermined by a provider.

As depicted in FIG. 5C, user device 103 may display GUI 500C. GUI 500C may appear in response to a user selecting to upload documentation. Upload window 507 may prompt the user (e.g., provider) to upload, via user device 103 and to processing device 101, any substantiating documentation. For example, a provider may upload test results for a test provided to the patient. Uploading the substantiating documentation may include appending or attaching the documentation files to the order so that the relevant information needed to perform claim processing and adjudication is included in a single file or data structure.

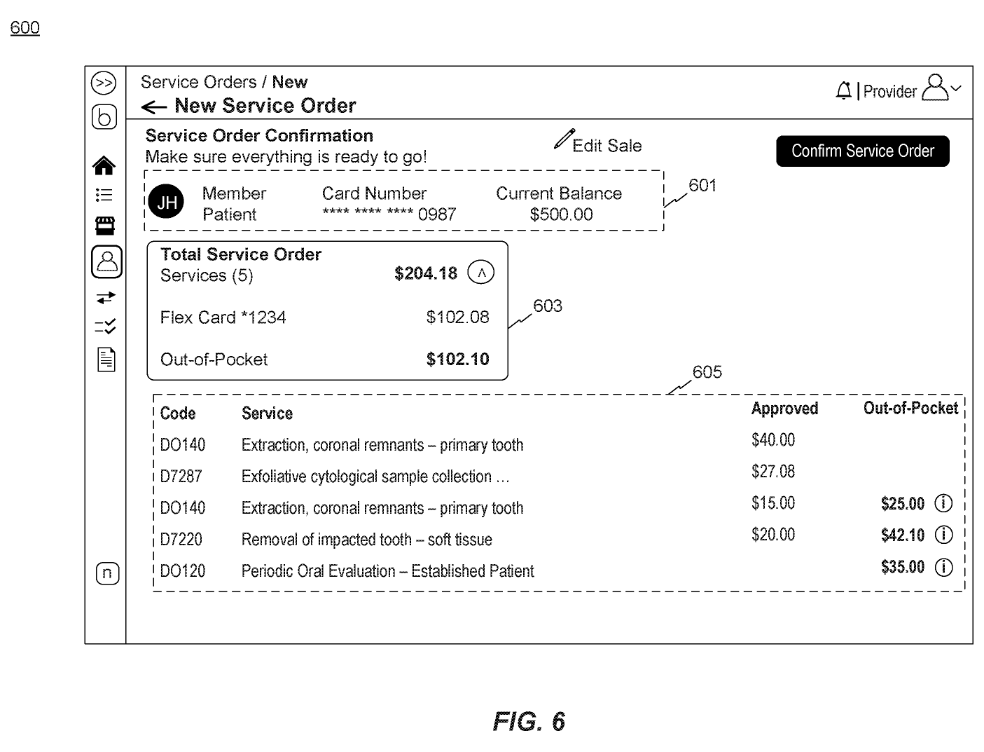

As depicted in FIG. 6, user device 103 may display GUI 600. GUI 600 may appear after a user selects to verify coverage or analyze the selected services. GUI 600 may include GUI element 601 configured to display member information, such as a name of the member, at least part of a PAN of the member, and/or a current balance associated with the member.

For example, user device 103 may transmit the order to processing device 101 via hybrid network 107B for claims processing and adjudication, as described and exemplified above. Processing device 101 may determine a cost associated with each selected element based at least on one or more program rules associated with the member identification. Processing device 101 may output, for display on user device 103, the determined cost for each selected good or service, including an approved cost and an out-of-pocket cost. For example, GUI element 603 may be configured to display a summary of the total order cost, an amount of cost that can be covered using member funds, and an out-of-pocket cost. GUI element 605 may be configured display a detailed view of each element of the order, the approved cost (e.g., can be paid for using member funds), and the out-of-pocket cost.

In some embodiments, based on determining that multiple plans are associated with the member, each having its own respective program rules and/or amount of funds (e.g., wallet), processing device 101 may apply each of the program rules to the received order in a manner that may minimize or reduce the out-of-pocket cost. By way of non-limiting example, processing device 101 may identify three programs associated with the received member identification. Processing device 101 may determine, based on the respective program rules, that: program A covers up to $50 of procedure X that costs $100; program B covers up to $50 of procedure X; and program C covers $100 of any procedure, including procedure X. In such an example, processing device 101 may determine, with or without using the machine learning model, that the funds from programs A and B should be applied to the procedure and not any funds from program C because the program C funds can be applied to a broader range of procedures. When transmitting the adjudication order to user device 103, processing device 101 may include a per program breakdown indicating which plans were applied to which elements. The breakdown may also include an explanation (e.g., as generated by the machine learning model) indicating why the programs were applied to each element.

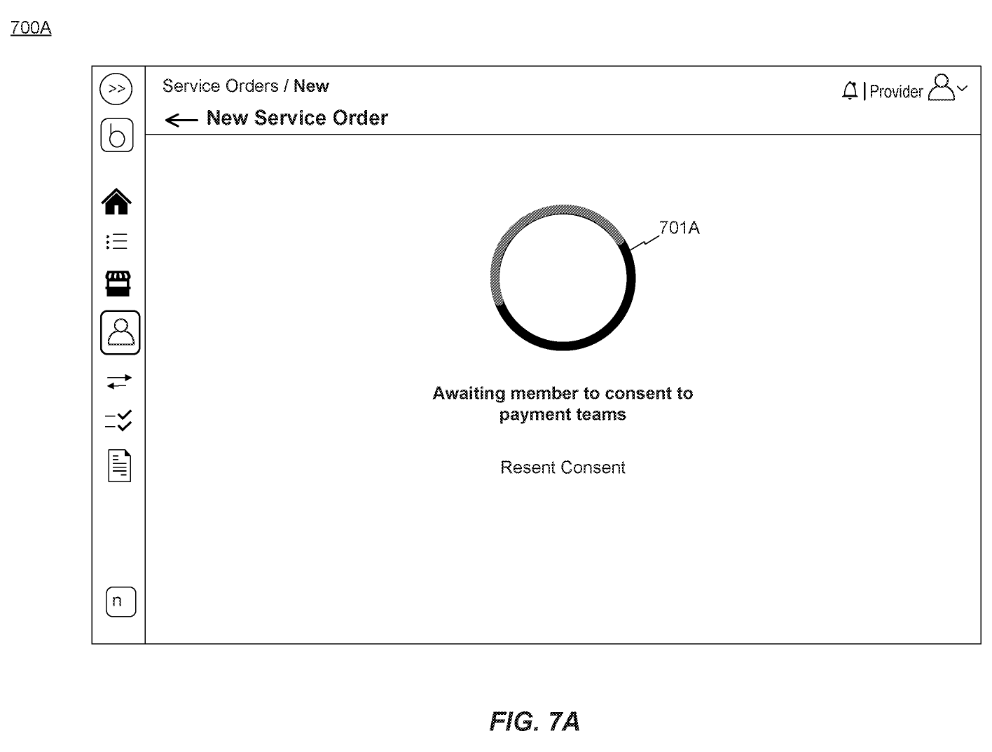

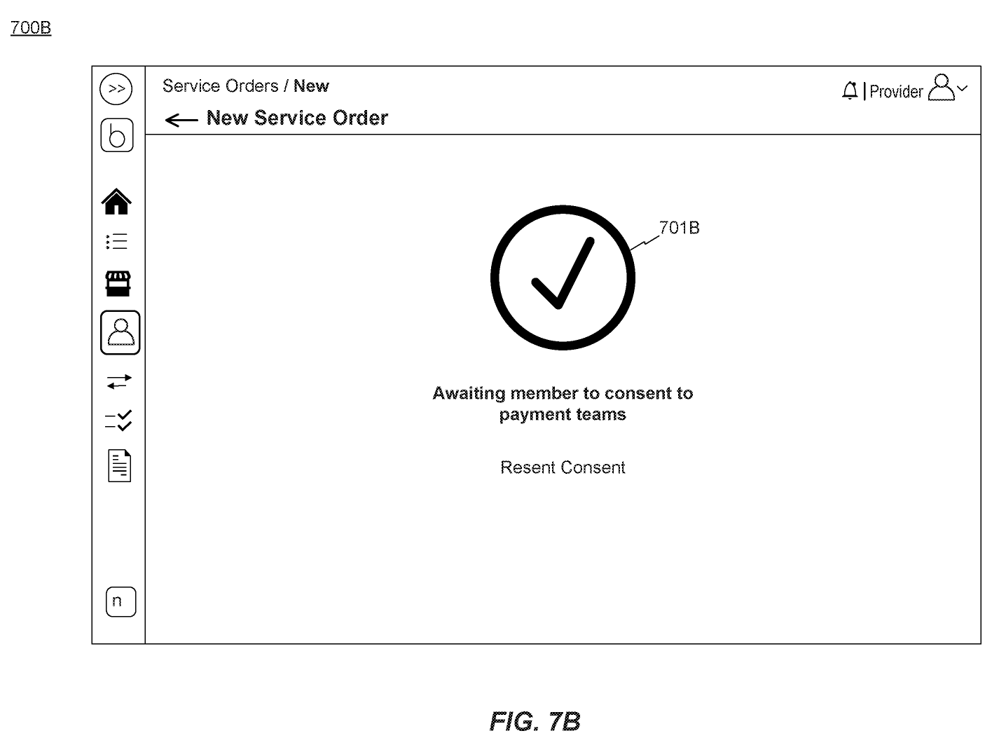

As depicted in FIGS. 7A and 7B, user device 103 may display GUI 700A while user device 103 is waiting to receive an authorized verification request from patient device 105 and GUI 700B upon receipt of confirmation from patient device 105. For example, user device 103 may display GUI 700A after transmitting the verification request to patient device 105 and may display GUI 700B after receiving the authorized verification request. GUI 700A may include GUI element 701A indicating that the verification request has been transmitted and that user device 103 has not received the authorized verification request. GUI 700B may include GUI element 701B indicating that the authorized verification request has been received by user device 103.

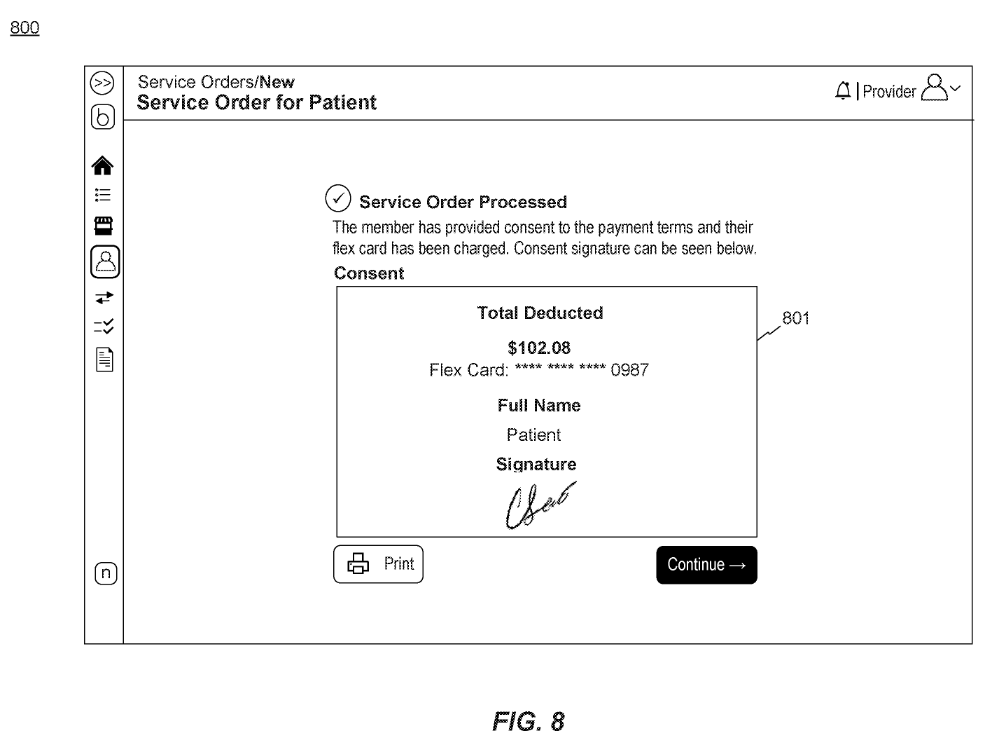

As depicted in FIG. 8, user device 103 may display GUI 800. GUI 800 may appear after processing device 101 receives the authorized verification request from patient device 105. Additionally or alternatively, GUI 800 may appear after processing device 101 authorizes the transferring of funds from an approved account to the intermediate account. GUI 800 may include GUI element 801 displaying a digital copy of the received authorized verification request.

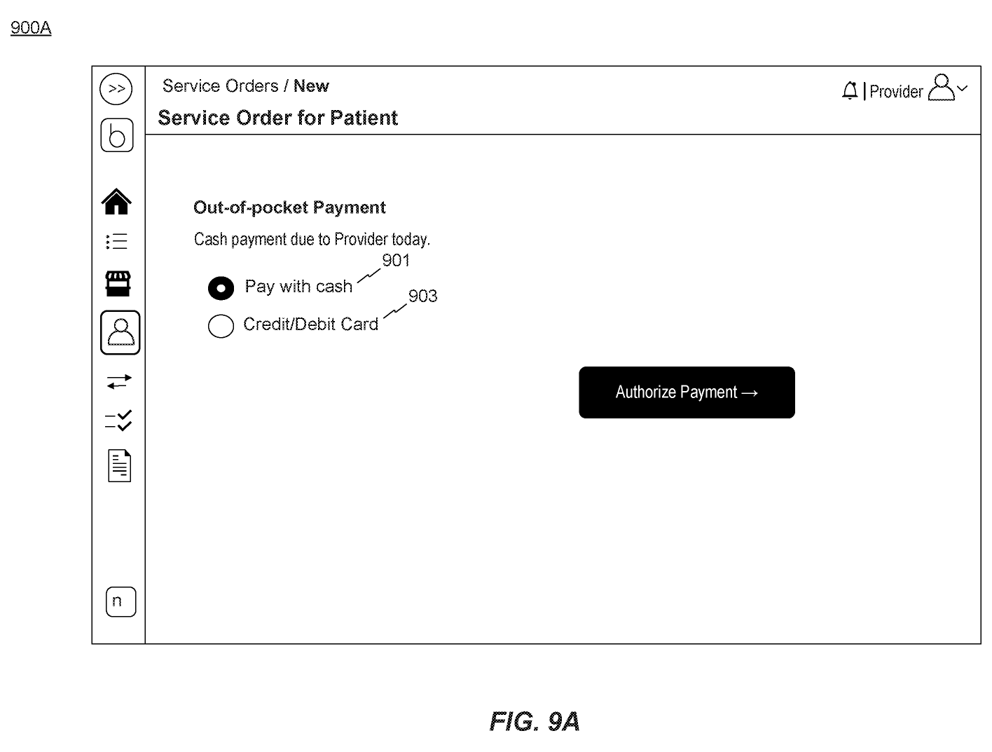

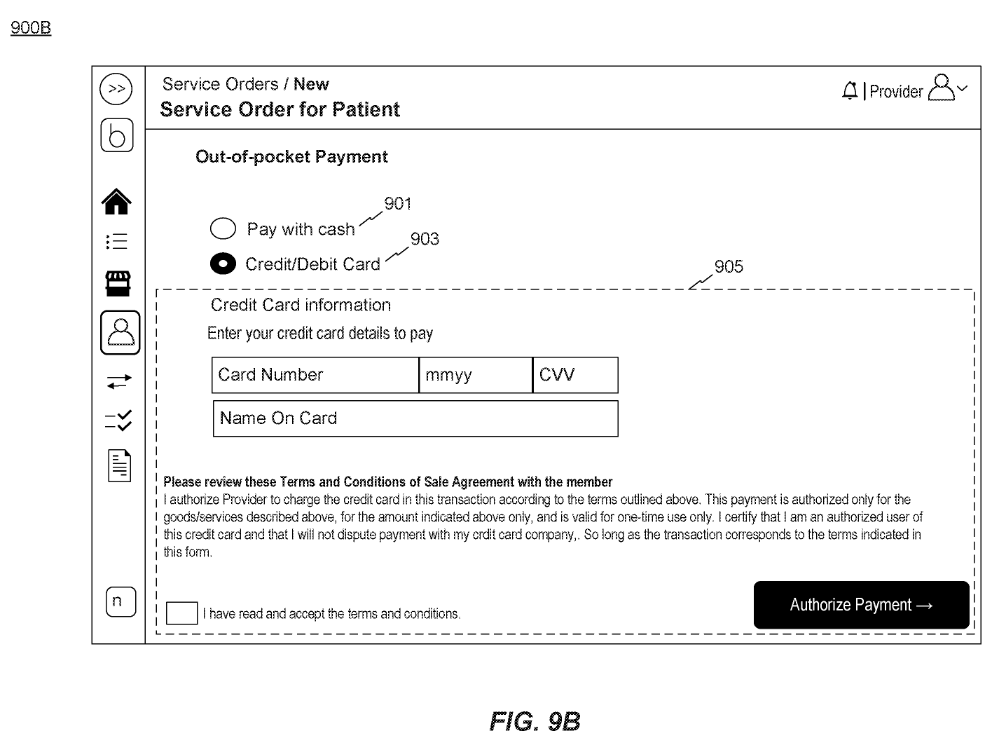

As depicted in FIGS. 9A and 9B, user device 103 may display either GUI 900A or GUI 900B based on a user selection. For example, if a user selects the “Pay with cash” GUI element 901, then user device 103 may prompt the patient and/or provider to facilitate a cash payment of the out-of-pocket cost using a POS device (e.g., cash register). If a user selects the “Credit/Debit Card” GUI element 903, then GUI 900B may prompt a user to input credit or debit card information in card information window 905. Additionally or alternatively, this information may be automatically filled by the patient presenting (e.g., via swiping, tapping, dipping) a credit or debit card to a POS device (e.g., card reader) connected to user device 103. In some embodiments, user device 103 may additionally or alternatively display a third GUI (not depicted) based on a user selection to pay the out-of-pocket cost using a Buy Now, Pay Later (BNPL) GUI element.

In some embodiments, user device 103 may transmit payment information to processing device 101. Processing device 101 may then transmit the payment information via open-loop network 107A to payment processing system 121. In some embodiments, user device 103 may transmit payment information to payment processing system 121 directly via open-loop network 107A.

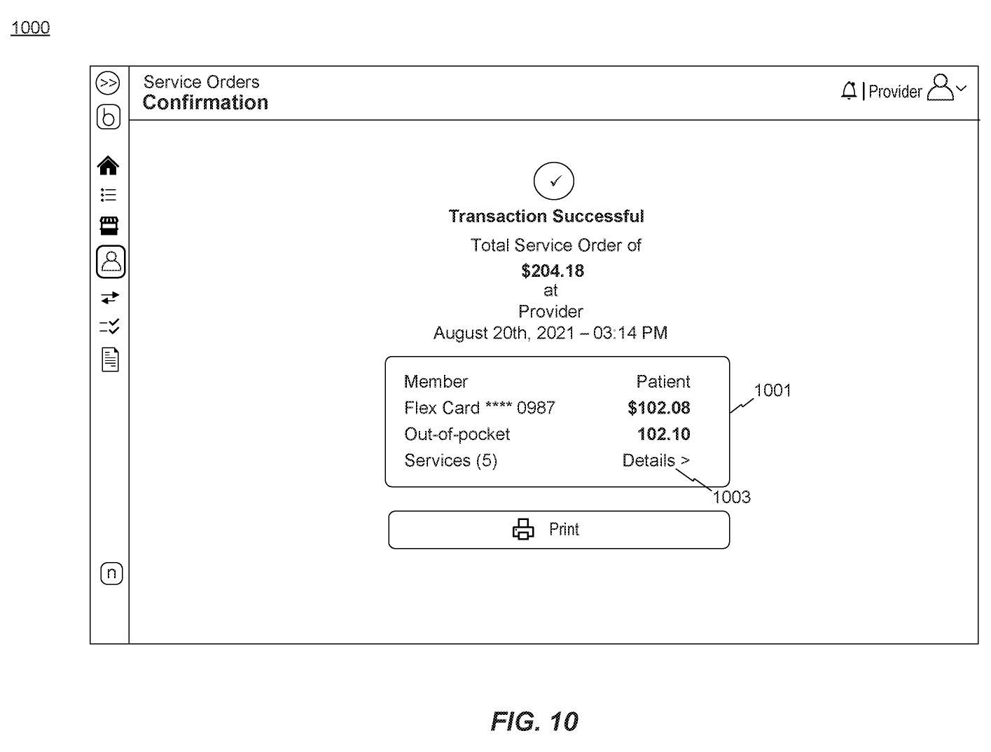

As depicted in FIG. 10, user device 103 may display GUI 1000. GUI 1000 may appear after the out-of-pocket cost is paid. This payment can include cash payment, debit/credit card payment, check, BNPL, any combination of the foregoing, or any other suitable payment method. GUI 1000 may include a GUI element 1001 configured to display confirmation of payment and a summary of costs paid. GUI 1000 may include a GUI element 1003 configured to, upon interaction (e.g., tap, click, select), display GUI 1100.

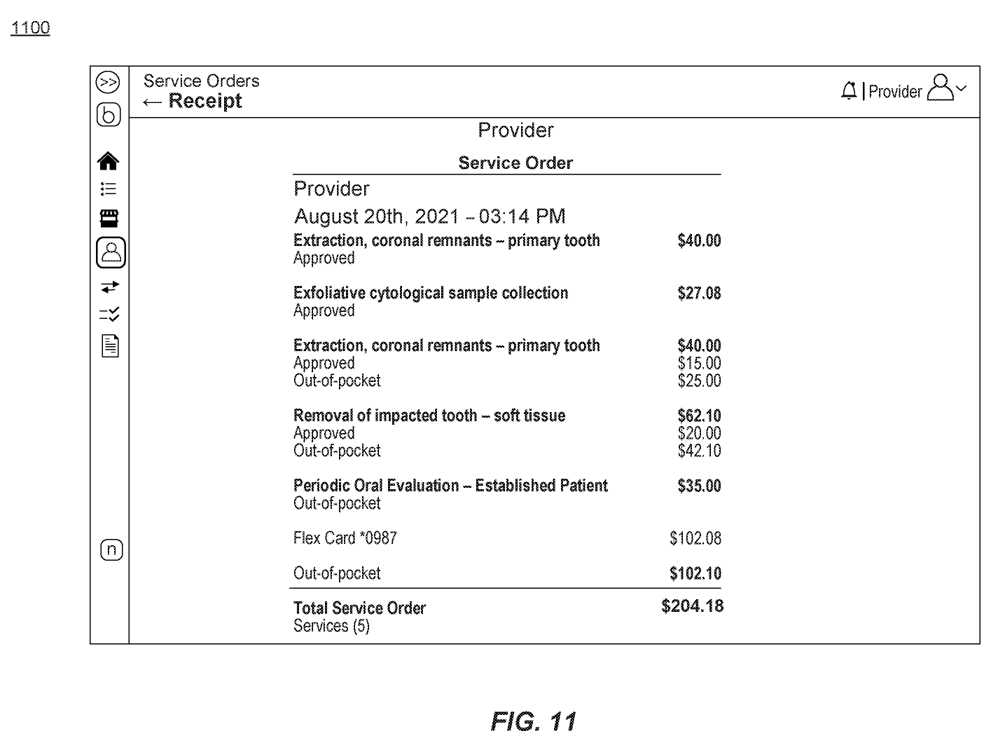

As depicted in FIG. 11, user device 103 may display GUI 1100. GUI 1100 may include an itemized receipt. Each item in the receipt may include a total cost, an approval status, and/or an out-of-pocket cost. In some embodiments, user device 103 may transmit the itemized receipt to patient device 105.

FIG. 12 illustrates an exemplary flow chart of a process 1200 for claims processing and adjudication, consistent with disclosed embodiments. Process 1200 may be implemented as software (e.g., in at least one module, at least one program, at least one application, and/or at least one function, etc.), hardware (e.g., processing device 101, user device 103), or a combination of both. For purposes of explanation, the steps of process 1200 are described as being carried out by at least one processor. The at least one processor may be, for example, processing device 101. While the steps of process 1200 are described below as being operated on processing device 101 (e.g., a SaaS or platform hosted by processing device 101 and operating on user device 103), in some embodiments, one or more steps of process 1200 may be operated by other devices, such as user device 103 and patient device 105. Process 1200 may include the steps or operations of a platform hosted by processing device 101 or any other device, such as the above-described claims adjudication and processing platform. In some embodiments, one or more steps of exemplary process 1200 may be repeated, omitted, and/or reordered.

In some embodiments, process 1200 may occur in real time. For example, a claim may be processed according to process 1200 by processing device 101 instantaneously or in a relatively short amount of time (e.g., a few milliseconds, a few seconds, 1 minute).

In step 1202, process 1200 may include receiving a user input. The user input may include a selection of one or more elements for inclusion in an order. For example, processing device 101 may output for display on user device 103, an interactable GUI in which the user may select (e.g., click, tap, type) the goods and/or services provided to the patient, such as GUIs 500A, 500B, and 500C. User device 103 may transmit the user input to processing device 101 via hybrid network 107B. In some embodiments, the user input may include data that may not be transmitted over open-loop network 107A, such as item-level data of the order.

In step 1204, process 1200 may include identifying one or more program rules. For example, processing device 101 may identify at least one set of one or more program rules associated with the order. Processing device 101 may identify the at least one set of program rules based on the order and/or a received membership information, using or not using the machine learning model. For example, a member may be associated with a plurality of programs, each of which having its own respective set of one or more program rules.

In step 1206, process 1200 may include determining a cost based at least on one or more program rules. For example, processing device 101 may determine an approved cost and an out-of-pocket cost for each selected good and/or service of the order based on the one or more program rules. In one example, processing device 101 may lower the total cost to a maximum cost if the total cost is greater than the maximum cost as dictated by a program rule.

In step 1208, process 1200 may include transmitting a verification request to a user device. For example, processing device 101 (e.g., through user device 103) may transmit a verification request to patient device 105. The verification request may include a cost breakdown of each good and/or service received from the provider as well as a signature field, which may be signed by typing or drawing a signature. In this way, the verification request provides instant transparency regarding the received goods and/or services and the associated costs (e.g., total cost, approved cost, out-of-pocket cost). Step 1208 may include recording and storing the authorization as part of an audit trail (e.g., in database 109).

In step 1210, process 1200 may include authorizing the order based on receiving the verification request. In some embodiments, processing device 101 may utilize the machine learning model to determine if the verification request is authentic. In such embodiments, after receiving the verification request, processing device 101 may instruct the machine learning model to determine a fraud value for the order. If the fraud value indicates no or little likelihood of fraud, processing device 101 may authorize the order by withdrawing or subtracting funds from the approved account.

In step 1212, process 1200 may include authorizing payment of the order. For example, processing device 101 may facilitate payment of an out-of-pocket cost with payment processing system 121 via open-loop network 107A.

Certain features which, for clarity, are described in this specification in the context of separate embodiments may also be provided in combination in a single embodiment. Conversely, various features which, for brevity, are described in the context of a single embodiment may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

The term “processor,” as used herein, refers to one or more processors. The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A computer-implemented method for claims processing and adjudication, the method comprising:
receiving, via a hybrid network, a user input selecting one or more elements for inclusion in an order;
identifying one or more program rules based at least in part on the order;
determining a cost associated with each selected element based at least on the one or more program rules;
sending a verification request to a user device;
based on receiving the verification request, authorizing the order; and
authorizing, via an open-loop network, payment of the order,
wherein the hybrid network and open-loop network are separate communication networks.

2. The computer-implemented method of claim 1, further comprising:
receiving, via the hybrid network, a member identification; and
verifying the member identification,
wherein identifying the one or more program rules is further based on the member identification.

3. The computer-implemented method of claim 2, wherein the member identification includes at least one of: a card identifier or a postal code.

4. The computer-implemented method of claim 1, further comprising recording and storing the user input and the verification request as part of an audit trail.

5. The computer-implemented method of claim 1, further comprising:
creating a training data set for a machine learning model based on historical transaction data; and
training a machine learning model using the training data set.

6. The computer-implemented method of claim 5, further comprising determining, using the trained machine learning model, a fraud value associated with the order.

7. The computer-implemented method of claim 5, wherein identifying the one or more program rules includes using the trained machine learning model to identify the one or more program rules.

8. The computer-implemented method of claim 1, wherein the determined cost includes at least one of: an approved cost, an out-of-pocket cost, a maximum cost, or a total cost.

9. The computer-implemented method of claim 1, wherein determining the cost occurs in real time.

10. The computer-implemented method of claim 1, further comprising:
receiving a second user input comprising one or more substantiating documents; and
recording and storing the second user input as part of an audit trail.

11. A system for claims processing and adjudication, the system comprising:
at least one processor; and
at least one non-transitory computer-readable medium containing instructions that, when executed by the system, cause the system to perform operations comprising:
receiving, via a hybrid network, a user input selecting one or more elements for inclusion in an order;
identifying one or more program rules based at least in part on the order;
determining a cost associated with each selected element based at least on the one or more program rules;
sending a verification request to a user device;
based on receiving the verification request, authorizing the order; and
authorizing, via an open-loop network, payment of the order,
wherein the hybrid network and open-loop network are separate communication networks.

12. The system of claim 11, wherein the operations further comprise:
receiving, via the hybrid network, a member identification; and
verifying the member identification,
wherein identifying the one or more program rules is further based on the member identification.

13. The system of claim 12, wherein the member identification includes at least one of: a card identifier or a postal code.

14. The system of claim 11, wherein the operations further comprise recording and storing the user input and the verification request as part of an audit trail.

15. The system of claim 11, further comprising:
creating a training data set for a machine learning model based on historical transaction data; and
training a machine learning model using the training data set.

16. The system of claim 15, further comprising determining, using the trained machine learning model, a fraud value associated with the order.

17. The system of claim 15, wherein identifying the one or more program rules includes using the trained machine learning model to identify the one or more program rules.

18. The system of claim 11, wherein the determined cost includes at least one of: an approved cost, an out-of-pocket cost, a maximum cost, or a total cost.

19. The system of claim 11, wherein determining the cost occurs in real time.

20. The system of claim 11, wherein the operations further comprise:
receiving a second user input comprising one or more substantiating documents; and
recording and storing the second user input as part of an audit trail.
